(19) United States
(12) Patent Application Publication
(10) Pub. No.: US 2002/0016676 A1
(43) Pub. Date: Feb. 7, 2002

(54) Climatic conditions based pest control management

(76) Inventor: Christopher Sann, Wilmington, DE (US)

Correspondence Address: Ratner & Prestia, P.O. Box 7228, Wilmington, DE, 19803, US

(21) Appl. No.: 09/912,943

(22) Filed: Jul. 25, 2001

Related U.S. Application Data
(60) Provisional application No. 60/220,736, filed on Jul. 26, 2000.

(51) Int. Cl. G06F 17/60; G01W 1/00; G06F 19/00; G06F 169/00

(52) U.S. Cl. 702/3; 705/1

(57) ABSTRACT

A method of predicting phenomenon related to climate, and a method of doing business using the prediction analysis is provided. Specifically, the prediction of pest growth and activity, as indicated by weather conditions is provided to assist in crop and turf management. The accuracy of the present prediction method is enhanced by supplementing historical average weather data with current year-to-date measurements and forecast data in the same analysis. The incorporation of current short-term data, along with historical average data provides sensitivity to climatic phenomenon. A method of doing business of providing prediction analysis for a fee through computer facilitated interface is also provided.

This application claims priority to a U.S. provisional application Ser. No. 60/220,736 filed Jul. 26, 2000.

### BACKGROUND OF THE INVENTION

1. Field of the Invention

This invention relates to plant pest control management practices and more particularly to a climatologically based method for calculating the optimal timing for the application of pest control measures at managed plant sites.

2. Description of Related Art

Most predictive models use historical average data, typically supplied by the month of year for a geographic region. This provides an indication of the “average year” growth conditions, but the average year temperature and precipitation values are often significantly different from any actual year's weather.

Plant managers and farmers recognize this and adjust practices accordingly. If a pest is known to have a growth cycle that typically begins in late spring, plant managers will plan pest control measure accordingly, and if the managers recognize that a particular year has a warmer and drier spring then an average year, they will expect the pest growth cycle to begin earlier, and apply pest control measures earlier. This approach to variations in seasonal pest growth conditions is not a systematic method, but rather an anecdotal response based on personal experience and knowledge by the plant manager or farmer.

As a practical matter, plant pest management has been a central concern of plant managers almost from the outset of plant cultivation practices several millennia ago. Currently, the annual investment in time, labor, chemical treatments, fertilization and equipment for the maintenance of turfgrasses and associated ornamental plants in so called landscapes is estimated to be in the tens of billions of dollars. A significant portion of this investment of resources in landscape management, as well as all other forms of plant management is devoted to the control of three basic classes of pests: weeds, diseases, and insects. Weeds constitute the largest pest class and as such they pose a tremendous problem for plant managers throughout the world. About 41% of the cost of all plant protection have been estimated to be for the control of weeds. Annually herbicides used for weed control are applied to more acres than applications of the agents to control diseases and insects combined. Although the application of herbicides provides many short-term benefits, such as increased crop yield, better quality nursery plants and food items, and more pleasing landscapes, the broad and extensive use of herbicides has been shown to be undesirable because the application of large quantities of herbicides can and does adversely effect the environment.

Diseases are a second class of pests that damage all manner of plants, including grasses, ornamental shrubs and trees, nursery, forest, and agricultural crops. Because of the microscopic nature of the disease causing agents, known as pathogens, disease control requires constant vigilance on the part of plant managers. Diseases, which have been estimated to reduce yields by up to 50% in crop species, are most often combated with the application of chemical fungicides.

A third class of plant pests are insects. Insects have historically been controlled by the application of insecticides. Historically, the broad toxicity, persistence, and extensive use of many insecticides has sporadically led to a range of unintended consequences, from resistant populations of insect species to extensive local fish and avian kills.

Pest control products in general raise several issues of concern. Many pest control products have toxicity levels that pose safety concerns for consumers and those applying the products. Some products are not specific to target pests and also affect non-target species. Finally, the sufficient amount of active ingredients must be applied to control the pests, but excessive amounts of active ingredients can have a detrimental impact on the environment.

Newer products have been introduced to reduce the unintended consequences of pest control. Many of the newer chemistries are intended to reduce the overall toxicity of products, narrow the list of target and non-target species, and/or substantially reduce the volumes of active ingredients required to control the pests.

Although the use of these newer products and alternative management strategies show promise in reducing the overall environmental effects of pesticide use, increased human population and the economics of plant production, continue to increase the total aggregate use of pesticides.

In addition to improved pesticide products, the methods of using these products have also recently improved. Research in plant pest management and in-field studies has shown that the application of pest control products when applied at an early developmental stage of the particular pest to be controlled, require less product to achieve control. Unfortunately, it can be difficult to determine the early stages of pest development. Some pests develop in the soil (such as grubs) or stems of plants, and are not visible. Other pests, such as fungal pathogens, are microscopic and are undetectable until significant damage is apparent.

Historically, the most common method used to determine the optimum timing for pest control applications has been a calendar-based system extrapolated from historical observations of previous years' pest activity. For example, Japanese Beetle adult feeding and egg-laying activity usually occurs in mid-July so pesticide applications for the control of immature Beetles is done near this date. The inherent limitation of this calendar-based system is the fact it ignores several primary pest activity factors, such as current and past temperatures and moisture conditions. For example, damaging Brown Patch disease infestations can be found in some turfgrass species in warm and humid conditions in early April, rather than its typical occurrence in mid-June through August.

Efforts by universities and research facilities have been made to improve the accuracy of the calendar-based system for pest life-cycle estimation. The results of these efforts include a Year-To-Day (YTD) temperature calculation called “accumulated Degree-Days.” This system recognizes the effect of YTD temperature accumulation on likely pest growth and attempts to describe that relationship by accumulating average daily temperatures above a predetermined threshold for that activity.

Pesticide application timing by using a so-called “degree-day model” has shown a substantial improvement in insect control efficacy over the previous calendar date only systems, but by its very nature, degree-day calculations are limited to estimations of only the current or likely life-cycle growth stage of the targeted insect species. Degree-day calculations fail to take into consideration the role that temperature accumulation below the predetermined threshold may play in a pest life cycle, or the role that other environmental conditions such as rainfall or soil moisture may play in pest development. Finally, degree-day calculations only estimate the likely current growth stage of the pest targeted and cannot describe the likely insect populations or levels of potential plant damage, because this model only monitors phenological life stage change.

Efforts to model disease infestations or outbreaks have met with somewhat less success than degree-day modeling for insects. Researchers at several universities and research facilities have created computer facilitated models that compare current or recent climatic factors, such as temperature and leaf wetness over a few hours or days, against a range of measured climatic factors that are known to be favorable for activity by a particular pathogen species. Once a predetermined occurrence criterion has been exceeded, a recommendation for the application of a control material is issued.

However, comparisons of current climatic conditions against known favorable conditions are but a snapshot of likely pathogen favorability during a limited time period and do not actually forecast disease activity. Experience has shown that estimations of disease activity based on these calculations do not correlate well to actual economically significant disease outbreaks.

Thus control measures may be unnecessary even though the current short-term climatic conditions indicate otherwise. Similarly because of this single test of below or above a preset level of climatic conditions, such methods do not provide guidance in determining the level of control measures required. As a result, the application of control measures may be either excessive or inadequate.

Therefore, there is still need, for a method for predicting damaging pest activity in a particular location, and at a particular time, often before visible damage has occurred, so as to assist plant managers in making strategic decisions for control of such pests by optimal and timely intervention.

### BRIEF SUMMARY OF THE INVENTION

The present invention provides a method for predicting an optimal time for the application of pest control measures in efforts to control a pest in an agricultural or plant management environment. This method includes developing a first parameter that correlates temperature to a growth index and another parameter correlating soil moisture to the same growth index for a given pest of interest. These parameters are stored in a data bank, and time related temperature and soil moisture data are obtained for a desired location. The growth index is indicative of one or both of pest population and activity in the desired location, and the method of the present invention includes calculating the growth index and showing the growth index of a pest as a function of time. The growth index is calculated by applying the parameters to the time related temperature and soil moisture data. A visual display of the calculated growth index for the desired location is shown as a function of time.

The present invention further includes a method of doing business. The method comprises developing a first parameter correlating temperature and a second parameter correlating soil moisture with a growth index for a pest and storing the parameters in a data bank. The methods further includes receiving a request from a client for predicting the growth index for the pest in a specified geographic region, and obtaining time related temperature and soil moisture data for that geographic region. The business method also includes calculating the growth index, which is indicative of pest growth activity for the pest in the specific geographic region, and showing one or both of activity and population of the pest as a function of time. This is done by applying said first and second parameters to time related temperature and soil moisture data from the specific geographic region. Next, the method includes generating a visual display of the calculated growth index for the specific geographic region as a function of time, and finally, supplying the client with the visual display.

The business method of the present invention may also include providing to a client for a fee, a service by subscription, wherein a subscribing client accesses a central computer and the client enters a desired geographic region and receives a display of a predicted pest growth index in the desired geographic region as a function of time based on historical, present and predicted temperature and rainfall for the desired geographic region. This method can be used by a manufacturer and/or distributor of pest control measures.

### BRIEF DESCRIPTION OF THE FIGURES

FIG. 1 schematically illustrates an exemplary growth index curve generated by the present invention;

FIG. 2 provides a coded map indicating relative growth favorability for a pathogen among climatic regions of the United States;

FIG. 3 illustrates a flow diagram representing the components of an embodiment of the present invention;

FIG. 4 provides a comparison between the degree day assessment of the present invention and conventional methods;

FIG. 5 illustrates a flow diagram representing the components of an embodiment of the business method of the present invention.

### DESCRIPTION OF THE PREFERRED EMBODIMENT(S)

Throughout the following detailed description, similar reference characters refer to similar elements in all figures of the drawings. In describing this invention reference will made to certain specific pests. Such references are by way of example and are not intended to limit this invention to the specific pests, geographic locations or plants named.

The present invention provides a method for predicting climatic related phenomenon. The method offers higher accuracy in predicting climatic related phenomenon, such as pest growth, because the method provides for the combination of historical average climate data with recent year-to-date measurements of climatic conditions. Additionally, short or long term forecast climate information can be incorporated into the prediction models with the present invention. By supplementing historical average weather patterns with updated, actual weather conditions, the prediction method is sensitive to the current seasonal conditions, rather than the average year conditions.

The method includes collecting climatic data. Climatic data may be collected from a variety of sources, including weather services, such as the National Oceanic Administration Weather Service, or a comparable public or private weather service, or climate data reporting network. Historical climatic data is often provided by weather services on a monthly basis for a geographic region. Sensitivity of the prediction models improves when data is apportioned in periods of time smaller than one month. A preferred period of time is one week. Historical data available for the month can be adapted to a weekly schedule through weighted apportionment.

The present invention provides for supplementing historical weather data with actual measured data for the year by apportioning climatic data according to the period of time in which it was collected. The actual measured data for the year can be collected through the same kinds of weather services, or collected on site by a consumer, or a service provider. Thus the present invention involves using local climatic data retrieved from a variety of sources such as the National Oceanic and Atmospheric Administration, NOAA, actual measured data for specific small locations, local weather reporting, state wide weather reporting, regional weather reports, and measured data and historical and predicted weather data spanning time periods of the order of one or two weeks to thirteen months. The weather data can be collected for large or small areas, and may be site specific.

In this method the data is categorized according to the source and nature of the data, i.e. whether the data is real-time or current measure data, historical average data for that area, or forecasted data. The real-time or current measure data are data specific for the current season or year, as determined from weather reporting services or actual weather measurements, such as temperature, humidity, and precipitation. Other types of climate measurements include wind and soil moisture data.

The historical average data represents the “average” year weather for a given period of time, i.e. a specific week of the year, for a given geographical location. Historical average data may vary in how many years of weather measurements are included, as well as the size of the geographical area represented. In some cases, historical average data may be accumulated through local weather records, or through records collected at a specific site. Such data collected over time, may be averaged on a monthly, weekly, or daily basis to provide a historical average data set at the desired location.

The forecast data set is collected from weather forecasting services, which provided predicted weather conditions. These forecast data may be short-term or long-term predictions.

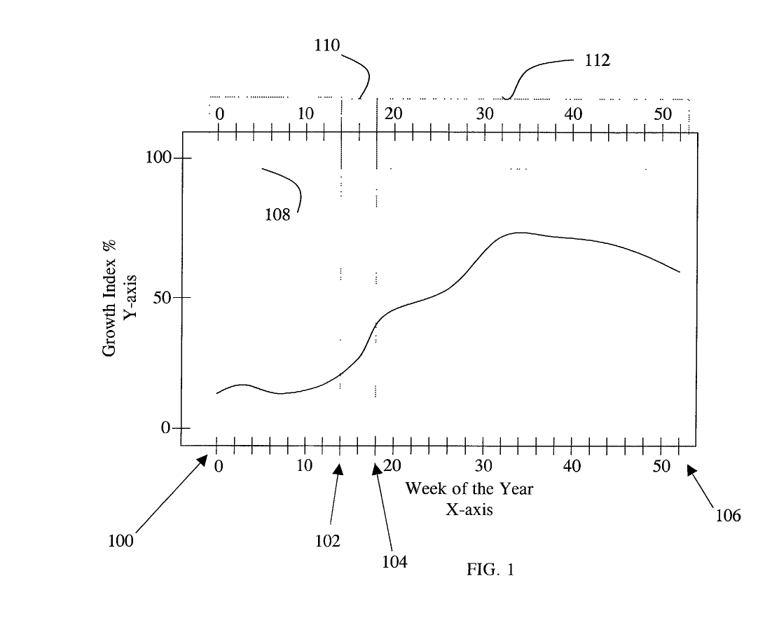

The method of the present invention includes establishing a cycle start point 100, a cycle end point 106, and a current cycle point 102, as shown in FIG. 1. In FIG. 1, the X-axis is time, apportioned into weeks of the year (two weeks per marker), and the Y-axis is a pest growth index factor, indicating the favorability for a particular pest's growth and activity. The growth index is a predictive indicator that is calculated by a computer modeling program, according to parameters relating climatic conditions to specific pest growth and activity patterns optimized by the computer program. Such programs are commercially available, or may be developed for specific applications through spreadsheet programs such as LOTUS 123 and MICROSOFT EXCEL. Specific computer modeling programs that include pest growth factor parameters and historical data include CLIMEX, and CRYSTAL BALL software programs. Other modeling algorithms have been developed as a result of research on pests and are available through research institutions or agricultural offices.

CLIMEX software is a commercially available product developed by Skarratt, D. B., Sutherst, R. W. and Maywald G. F. for use with WINDOWS in a personal computer. CLIMEX is used in predicting the effects of climate on plants and animals, and is available from The Software Applications Officer of CRC for Tropical Pest Management, of the Gehrman Laboratories at the University of Queensland, Brisbane, Queensland 4072, Australia.

This program was originally developed in 1985 as an MS-DOS version to permit researchers to estimate the potential geographic distribution of a species using climatic preferences derived from a known distribution and historical climatic data. The program allows users to display results as graphs and maps.

CLIMEX is a dynamic simulation model which enables the estimation of an animal or plant's geographic distribution and relative abundance as determined by climate. The program models different species by selecting parameters which describe the species' response to temperature and moisture. The program generates a growth index number that indicates the potential growth of the species and the probability of the species surviving depending on the season. Modeling algorithms are provided in CLIMEX for parameter fitting and graphical display. Details of these functions are provided in the CLIMEX operator's manual, incorporated herein by reference in its entirety. The product is intended to provide geographic distribution maps showing the spread of the species at different locations around the world.

Modifications may be necessary to some of the available software to facilitate entry of historical, real-time and forecast data, but the modeling algorithms remain functional for the present invention. In such cases, the spreadsheets will be programmed to provide functions or algorithms that allow for analyzing the correlations between the growth potential of a pest and the soil moisture and temperature histories. These functions and algorithms may provide various degrees of sophistication in generating estimation models. Preferably soil moisture should correlate to rainfall and/or humidity, as rainfall and humidity data are typically easier to obtain than soil moisture conditions. Spreadsheet and modeling programs used according to the present invention correlate climatological data to pest response projections. The programs provide time-related data that show current and future growth potential for the pest in question. Preferably, such programs provide a visual output of the expected growth potential as a function of time based on the temperature and soil moisture data available.

The method of the present invention further includes dividing the cycle into a number of data pockets. The data pockets correspond to a period of time. Preferably the data is apportioned into weekly units of time, although the time period may be larger or smaller to optimize the prediction analysis. In the example charted in FIG. 1, the data pockets for the calculation are 1 week in length. Once the size of the data pockets has been established, data can be assigned to the data pockets by category. Typically, real-time data 108 is assigned to data pockets before the current cycle point 102, and the forecast data 110 to data pockets after the current cycle point 102.

A future cycle point 104 may also be established, which designates where current forecast data 110 is replaced by historical average data 112 for the remaining weeks of the year.

A modeling program is then applied to the data and at least one predictive indicator is calculated using modeling algorithms correlating climatic parameters with pest growth and activity. These parameters and the temperature data are correlated through a climatic pest distribution model. A climatic pest distribution model is typically a computer implemented program providing a dynamic simulation which enables the estimation of the geographic distribution and relative abundance of a species as a function of climatic conditions.

The modeling program provides the prediction information to a user by generating some type of visual display. This output may be in the form of a table or chart expressing the value of the predictive indicator as a function of time.

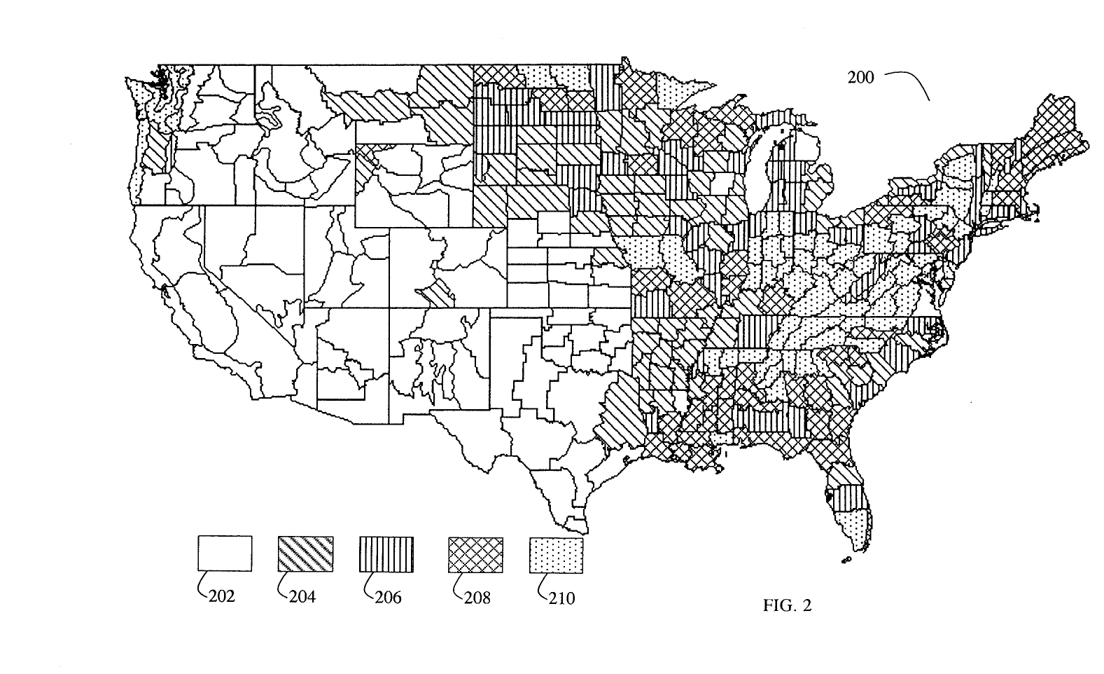

For providing predictive indicators for larger geographical regions, coded maps may be formed to display the modeling results. An example of a coded map showing the weekly favorability of the Dollar Spot turf pathogen in the U.S. is shown in FIG. 2. This presentation of information would be useful for pest control product suppliers and distributors, as the map shows that there is an increased likelihood that there will be a high demand for Dollar Spot fungicide in the eastern part of the country, and little demand in the central and western regions of the country. Equipped with such prediction information, a product supplier could redistribute supplies of pest control products to the east coast to reduce inventory costs, and to adequately meet demand.

The map shown in FIG. 2 shows the climatic regions and states in solid lines, and the relative growth favorability is displayed through shading or markings in the climatic region. There are five levels of favorability shown: zero 202; low (0-25%) 204; medium (25.1-50%) 206; high (50.1-75%) 208; and extreme (75.1-100%) 210.

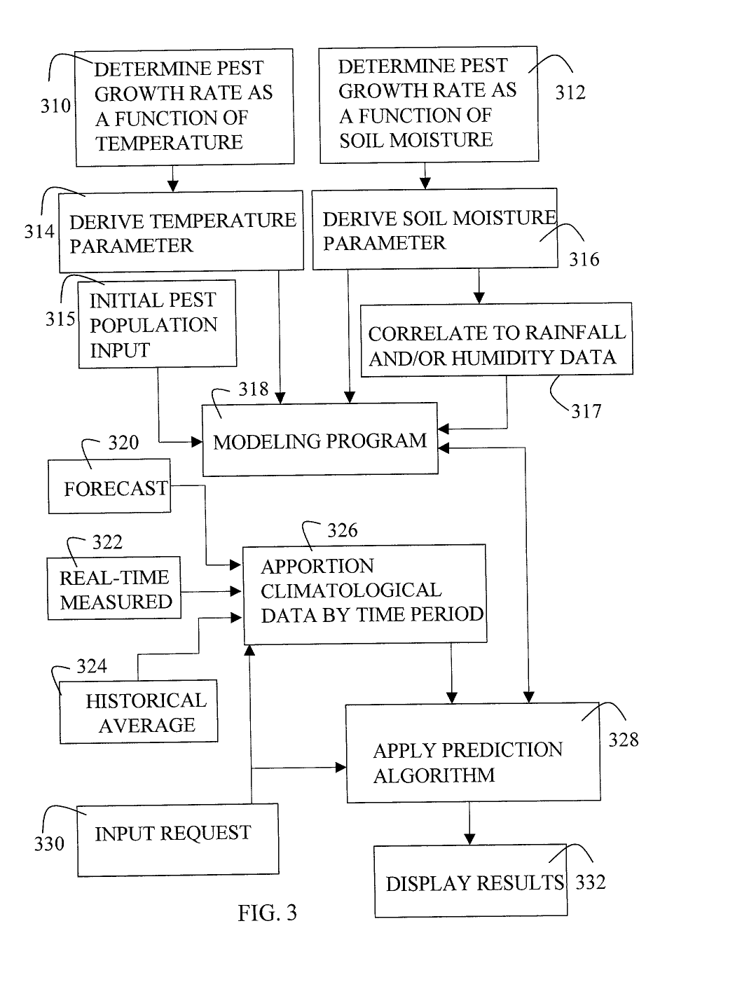

A block diagram is shown in FIG. 3 which provides an example of how the present invention may interface with a modeling program that correlates climatic data with pest growth parameters, such as described above. The growth rate for a particular pest as a function of temperature 310 and soil moisture 312 is determined. From this determination a temperature parameter 314 and a soil moisture parameter 316 are calculated. Modeling programs may use a number of field and laboratory results in determining the soil moisture and temperature parameters for specific pests. Soil moisture may be correlated to rainfall and/or humidity 317 data. This may be done by taking actual soil moisture measurements at selected geographical locations representative of the type of soils and ground conditions typical of the areas in which particular plants are grown. With soil moisture correlation data, weather information in the form of rainfall or humidity measurements can be incorporated into the model to calculate a soil moisture parameter. Therefore, the program can make the conversion to soil moisture rather than requiring actual soil moisture measurement data, which may be more difficult to obtain. For example, stored correlation data may exist for clay, sandy, and mixed soils in open, partly shaded and fully shaded areas as a function of rainfall over time. Therefore, the temperature and soil moisture data for a desired location can be obtained as a function of temperature and rainfall of a geographic region. By identifying the desired area only rainfall data is necessary to obtain a soil moisture figure for use by the growth prediction algorithm 328. Similarly, humidity measurements can be correlated to soil moisture as well.

The temperature and soil moisture parameters, along with any rainfall or humidity correlation information are stored in a database within the modeling program software 318. These stored parameters can be combined with climatic data 326 and an algorithm applied thereto 328. The climatic data is apportioned 326 from various sources, including forecast data 320, year-to-date measured data 322, and historical average data 324. When a request is put into the system 330, the data is retrieved and apportioned according to the information request, and the modeling program 318 is accessed to provide the appropriate correlation parameters and modeling functions, and the prediction algorithm is applied 328. The modeling results are then displayed or reported 332.

The growth index is calculated by applying the parameters along with the local temperature and soil moisture data to a climatic pest distribution model. The climatic pest distribution model is typically a computer implemented program providing a dynamic simulation which estimates the geographic distribution and relative abundance of a species as a function of climatic conditions.

The predictions generated by the modeling process can assist managers in selecting a time for applying a pest control measure in a desired area. The managers can select pest control measures from a display of growth index as a function of time. Typically, the ideal timing for pest control measures is after the increase in growth index and before damage to the plant.

As the present invention offers flexibility in which data are analyzed and a wide range of geographical locations, it provides a method of doing a business providing prediction services. The method of doing business similarly involves computer facilitated analysis in providing these services. The method includes collecting time related climatic data. This data may be stored in a computer database, or as discussed above, provided by the service provider or a customer for a particular site. If the climatic data is supplied, even if only in part, by a customer of service provider, there may be several mechanisms for the climatic data entry. The climatic data may be entered directly onto a website, or otherwise sent electronically to the prediction services account. Field sensors which collect weather information may send measurements directly to the prediction service provider on a regularly scheduled basis.

The business method further includes receiving a request for at least one predictive indicator related to the climatic data. This request may be received through any communication, but preferably is conducted through a website interface. The request may be in the form of a standing request, such as a subscription for weekly analysis of the predictive indicator of choice.

The predictive indicator may be any type of calculated factor. Typically, growth index factors that weigh degree days and soil moisture in determining growth conditions for pest is calculated. However, any type of climatic phenomenon can be predicted. Requests may include prediction analysis of the population of pests surviving the dormant season, or an analysis to assist in determining seed viability in early season soil.

Once a request has been received and the appropriate data collected, a modeling program is applied to the data and the desired predictive indicator is calculated according to the data and model parameters. The customer receives the results of the prediction analysis through a report, which is typically a visual display of the predictive indicator as a function of time, as discussed above. The graph shown in FIG. 1 and the map 200 shown in FIG. 2 are examples of how the calculations may be presented. The map represents the estimation level as a function of time in that the map illustrates the favorability pattern for the current week. The map represents a single point in time on the growth favorability curve, for several different data sets collected from the various geographical locations. The calculations may also be reported in the form of a table which correlates time, location and predictive indicator level in tabular form.

Depending on the time frame of the available data, the method may further include aggregating the climatic data by week. Since superior prediction results are obtained when climatic changes are adjusted on a weekly, rather than the typical monthly basis, it is advantageous to apportion data into weeks, or days for the most sensitive assessments.

Another method of doing business includes providing access to a central computer for a fee, such as by subscription. The subscribing client has access to the computer site to perform the desired analyses. The computer houses modeling software programs that calculate various predictive indicators. The computer also has a database of historical average, real-time and forecast data for a variety of geographic locations, and a mechanism for generating a visual display of the calculations performed. The display provides options such as plotting the predictive indicator for a requested geographic region, or as a function of time for a specific geographical location.

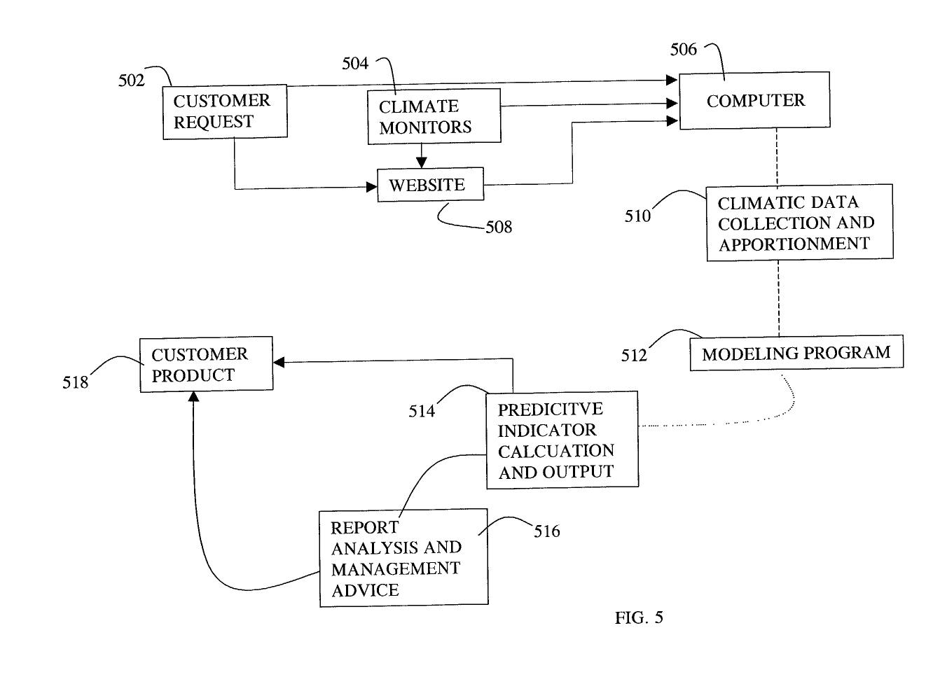

This method of doing business is represented schematically in FIG. 5 as the block diagrams represent various elements of the method. A customer makes a request 502, which may be accompanied by a fee payment. The request can be made through an internet website 508 or through other means to the business. A databank containing climatic data 510 is provided on a computer 506. The computer may either store the climatic data apportioned according to time periods most frequently used in analysis, or the computer apportion the data for each request 510. The central computer 506 may collect real-time climatic data from weather monitors 504 positioned in specific geographical locations, such as the customer's location. The data from such monitors can be submitted through an internet website 508, or otherwise loaded onto the computer 506. Temperature and soil moisture parameters correlating temperature and soil moisture to the growth curves of targeted pest species are contained in the modeling program 512. These parameters are used by a modeling program, such as CLIMEX, to calculate a predictive indicator 514. The results of the modeling program can be sent directly to the customer, as the customer product 518, or an analysis report can be generated and management advice 516 provided according to the results of the prediction analysis as the customer product 518.

In an alternate arrangement, the customer may subscribe to a continuing service agreement and have direct access to the computer 506 through an internet website 508, or other means. This would permit request input directly bypassing a system manager to obtain results directly so that the customer may acquire predictive information on demand.

The present invention provides substantially superior guidance to agricultural managers and product distributors due to the incorporation of recent measured data, forecast data and historical average data. The integration of these various data sets is made possible by a unique apportionment process. Each type of data are apportioned into short lengths of time, such as a week, and therefore the predictions can be updated with current measured data and updated forecast information on a very recent time scale. Therefore, the present invention fundamentally provides a method of apportioning data for use in any computer modeling program. The data apportioning method includes collecting time related data and apportioning the data into equal time periods. The data is then categorized into a variety of data sets, such as a past time data set; a present time data set; and a predicted data set for a future time. A number of lengths of time (weeks) are assigned to the past time data set; and another number assigned to the present time data set; and another number assigned to the predicted data set. The data sets may be weighted according to the magnitude of the number of time periods assigned to the particular set.

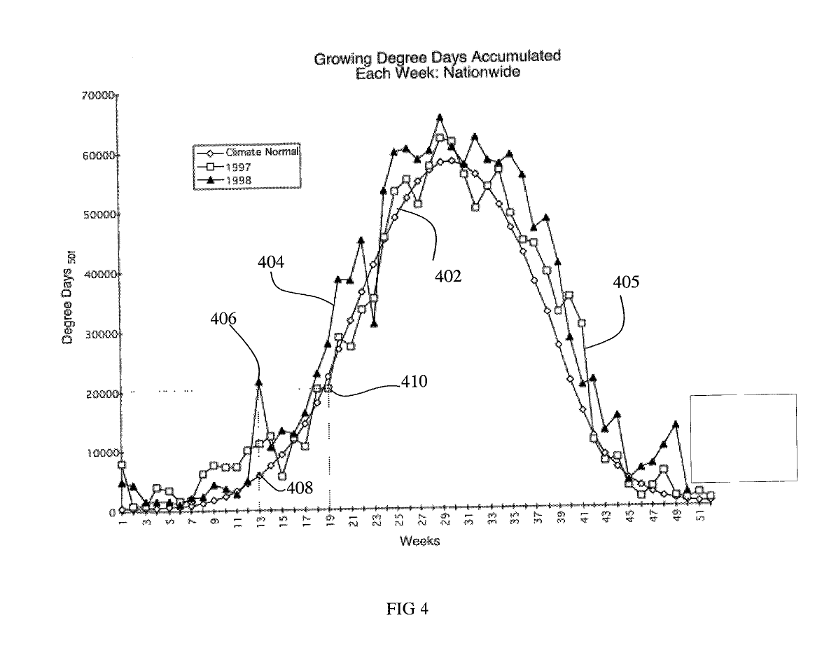

Effective management of pests can be accomplished by employing the methods of this invention as the manager is supported with information indicative of the state of growth and activity of a desired pest for a specific location. The plot shown in FIG. 4 illustrates how the present invention prediction analysis compares with conventional prediction models utilizing only historical average climate data. The predicative indicator plotted on the Y-axis is the accumulated degree days value, and weeks of the year are plotted on the X-axis. The diamonds indicate the degree days curve using historical 30 year average data 402 nationwide for the U.S. The triangle symbols indicate the weekly accumulated degree days curve for a particular year (1998), calculated on a weekly basis 404. A similar curve is shown for the weekly calculation of 1997 degree days 405. These curves 404 and 405 illustrate the advantage of calculating climatic indicators with current year data.

While the current year curves 404, 405 share a similar Bell-curve shape with the historical average curve 402, the curves generated through the present method 404, 405 diverge significantly from the 30-year average curve 402 at various points. For example, the degree days value generated through the present invention for week 13 was calculated using actual measured data. This week 13 degree days value 406 is a significantly higher than the corresponding week 13 point 408 on the 30 year average curve. This variation is significant as pest growth cycles are commonly activated at a threshold degree days value. For example, if a particular pest began its growth cycle when degree days values reached 20,000, then the 30 year average curve 402 indicates that the growth cycle does not begin until week 19. Accordingly, agricultural managers would likely apply pest control measures around week 19 to eliminate the pest at the beginning of the growth cycle. However, the curve generated using the present year's data 404 indicates that the degree days value at week 13 was above the threshold value of 20,000, indicating that pest control measures should be applied at week 13. A delay of pest control applications of six weeks from week 13 to week 19 allows the pest population to mature for six weeks after the initiation of the growth cycle before any treatment is applied. Such a delay results in additional plant damage and ultimately necessitates larger quantities of pest control measures.

Those having the benefit of the foregoing description of my invention may provide modifications to the embodiment herein described, such as using different climatic data input sources, modeling programs, connecting networks, web cites that permit direct access by subscribers of selected or preselected features etc. These modifications are to be construed as being encompassed within the scope of the present invention as set forth in the appended claims wherein I claim:

1. A method for predicting a climatic related phenomenon, the method comprising:
(a) collecting climatic data;
(b) categorizing the data as real-time data, historical average data, or forecast data;
(c) establishing a cycle start point, a cycle end point, and a current cycle point;
(d) dividing the cycle into a number of data pockets;
(e) assigning the real-time data to data pockets before the current cycle point, and the forecast data to data pockets after the current cycle point,
(f) applying a modeling program to the data and calculating at least one predictive indicator;
(g) generating a visual display of said predictive indicator as a function of time.

2. The method according to claim 1 wherein the climatological data includes one of more from the group consisting of rainfall, humidity, temperature, wind, and soil moisture data.

3. The method according to claim 1 wherein the cycle start point and the cycle end point are separated by one year, and wherein the number of data pockets is 52.

4. The method according to claim 1 wherein step (e), the real-time data is assigned to data pockets from the cycle start point to the current cycle point, the forecast data is assigned to data pockets after the current cycle point to a future cycle point.

5. The method according to claim 4 wherein step (e) further comprises assigning historical average data to data pockets from the future cycle point to the cycle end point.

6. The method according to claim 1 wherein the climatological data are connected with the same geographical region.

7. The method according to claim 1 wherein the modeling program relates the climatological data to a growth favorability factor for pests.

8. The method according to claim 1 wherein the climatic related phenomenon is pest development and the predictive indicator is a pest growth index.

9. The method according to claim 8 wherein the step of calculating said growth index is performed by applying a set of parameters and the temperature data to a climatic pest distribution model.

10. The method according to claim 9 wherein the climatic pest distribution model is a computer implemented program providing a dynamic simulation which enables the estimation of the geographic distribution and relative abundance of a species as a function of climatic conditions.

11. A method of doing business, said method comprising:
(a) collecting time related climatological data;
(b) receiving a request for at least one predictive indicator related to the climatological data;
(c) applying a modeling program to the data and calculating said predictive indicator;
(d) generating a visual display of said predictive indicator as a function of time; and
(e) reporting the modeling program calculations for a fee in response to said request.

12. The method according to claim 11 wherein the climatic data include historical average data, real-time data; and forecast data.

13. The method according to claim 12 wherein the climatic data further comprises site specific data.

14. The method according to claim 11 further comprising aggregating the climatic data by week before step (c).

15. The method according to claim 11 wherein the climatic data are specific to a geographic region.

16. A method of doing business comprising providing to a client for a fee, a service by subscription, wherein a subscribing client accesses a central computer in which there is stored:
(a) at least one modeling program to calculate a predictive indicator;
(b) historical average, real-time and forecast data for a plurality of geographic locations, and
(c) a program for generating a visual display of the calculated predictive indicator for a requested geographic region as a function of time; and
wherein said client enters a desired predictive indicator, and a desired geographic region and said client receives a display of the desired predictive indicator in said desired geographic region as a function of time.

17. The method according to claim 16 wherein said client is one or both of a manufacturer and distributor of pest control products and wherein said display guides said one or both of the manufacturer and distributor of pest control products in production, distribution or stocking of pest control products.

18. The method according to claim 16 wherein said historical average, real-time and forecast climatic data is supplied from a weather service provider.

19. The method according to claim 18 wherein said weather service provider is the National Oceanic Administration Weather Service or a comparable public or private weather service or climate data reporting network.

20. The method according to claim 16 wherein said client submits climatic data to be used in calculating the predictive indicator.

21. A method of apportioning data for use in a computer modeling program, the method comprising:
(a) collecting time related data;
(b) apportioning time related data into a plurality of equal time periods;
(c) categorizing the data into one of a data set measured at a past time; a data set measured at a present time; and a predicted data set for a future time;
(d) assigning a first number of the equal time periods to the data set measured at a past time; a second number of the equal time periods to the data set measured at a present time; and a third number of the equal time periods to the predicted data set.

22. The method of claim 21 further comprising a step of weighting the data sets according to the magnitude of the first, second and third numbers.

23. The method of claim 21 wherein the plurality of equal time periods is weeks of the year.
